(19) United States
(12) Patent Application Publication
(10) Pub. No.: US 2017/0239676 A1
(43) Pub. Date: Aug. 24, 2017

(54) HIGH PRESSURE CLEANER WITH ADJUSTABLE PRESSURE OR FLOW LEVEL

(71) Applicant: Nilfisk A/S, Brøndby (DK)

(72) Inventor: Mikkel Aggersbjerg Kristensen, Herning (DK)

(21) Appl. No.: 15/504,273

(22) PCT Filed: Aug. 14, 2015
(86) PCT No.: PCT/DK2015/050237

§ 371 Date: Feb. 15, 2017

(30) Foreign Application Priority Data
Aug. 15, 2014 (EP) 14181131.5

(51) Int. Cl. B05B 12/00; B08B 3/02; B05B 9/04

(52) U.S. Cl. CPC B05B 12/002; B05B 9/0403; B08B 3/026

(57) ABSTRACT

A high pressure cleaner with adjustable flow and/or pressure. A controller (CTL) serves to receive a wireless control signal (WCS) from a remote control unit (RCU), e.g. integrated in the spray handle (SH), in response to an input from a user. The controller (CTL) controls the high pressure module (HPM), e.g. electric power to its electric motor, so as to adjust a flow and/or pressure level at the liquid output (L_O) of the high pressure module (HPM) in accordance with the wireless control signal (WCS), between a plurality of different flow and/or pressure levels in an active state of the high pressure module (HPM). Further, the controller may be arranged to switch off electric power to the motor of the high pressure module (HPM) and/or activate a safety valve in response to a wireless control signal (WCS). The user interface (U_I) that allows the user to enter the desired flow and/or pressure level, may further visualize the flow and/or pressure level to the user.

### FIELD OF THE INVENTION

The present invention relates to the field of high pressure cleaners. Especially, the invention provides a high pressure cleaner with a wireless remote control to allow a user to adjust flow and/or pressure delivered by the high pressure cleaner.

### BACKGROUND OF THE INVENTION

High pressure cleaners are popular devices for cleaning various materials using a liquid such as water or water with an added detergent. A high pressure module transfers water at low pressure to a high pressure, e.g. by a high pressure pump driven by a 115/230 V electric motor. Via a flexible hose, the high pressure water is supplied to a spray handle with a nozzle at its tip. This spray handle allows the user to navigate the high pressure water from the nozzle to a target area to be cleaned. Typically, the spray handle has a trigger connected to a valve that allows the user to start/stop the flow of water during a cleaning procedure.

EP 1 060 800 A2 describes a high pressure cleaner with a machine body with a high pressure module. A remote control in the spray handle can transmit a wireless radio signal to a receiver in the machine body, so as to allow start and stop the electric motor of the high pressure module from the spray handle. Together with a ball valve with a spring for contrasting the delivery of flow, which can be set to a preset pressure, the start/stop function has been provided by the remote control instead of the conventional triggered start/stop valve in the spray handle. However, such high pressure cleaner still has a rather high water consumption, since the user will need to use full flow and/or pressure provided by the high pressure module when activating cleaning, since the electric motor will either be switched on (full flow/pressure state), i.e. an active mode, or it will be switched off (zero flow/pressure), i.e. an inactive mode. Thus, the high pressure cleaner consumes a large amount of (drinking) water, and a related problem is to remove the large amount of dirty water produced during a cleaning job.

### SUMMARY OF THE INVENTION

Thus, according to the above description, there is a need for a high pressure cleaner with a reduced water consumption.

In a first aspect, the invention provides a high pressure cleaner with adjustable flow and/or pressure, comprising

a high pressure module arranged for transferring liquid from a low pressure at a liquid input to a high pressure at a liquid output, and

a controller arranged to receive a wireless control signal from a remote control unit in response to an input from a user, wherein the controller is arranged to control the high pressure module so as to adjust a flow and/or pressure level at the liquid output between a plurality of different flow and/or pressure levels in an active state of the high pressure module, in accordance with the wireless control signal.

Such high pressure cleaner is advantageous, since it can save water because the user can select between different levels of flow and/or pressure level from a wireless remote control unit, e.g. a radio control placed in the spray handle of the high pressure cleaner, during the high pressure module being in an active state, i.e. with the motor switched on. Hereby, the user can increase or decrease water consumption according to the needs during cleaning, and thus water consumption can be reduced to a minimum level, and as a result of this, problems with removal of large amount of dirty or maybe even poisonous liquid resulting from the high pressure cleaning will be limited. Furthermore, an untrained user can be guided in the user of the high pressure cleaner in case a number of different flow and/or pressure levels are selectable, e.g. by means of a guidance for selection of appropriate levels to different types of cleaning tasks. This may provide the user with a feeling of safety when using the high pressure cleaner e.g. for cleaning of fragile materials etc.

It is to be understood that the different flow and/or pressure levels may be indicated to the user in various ways, e.g. as percentage of a maximum available flow and/or pressure, such as a percentage of electric power applied to the electric motor in the high pressure module. E.g. 2-10 different levels, such as 3-7 different levels may be selectable by the user. Alternatively, the user may be allowed to steplessly selecting a level between at minimum and a maximum setting. A user interface may comprise a turning knob, a touch panel, or “up” “down” push buttons to allow the user to select the flow and/or pressure level setting.

The remote control unit may especially be positioned in the spray handle, e.g. with control knobs on the surface of the spray handle. Alternatively, or additionally, the remote control unit can be a separate unit, e.g. a dedicated remote control unit dedicated to the high pressure cleaner, i.e. a stand-alone unit.

By ‘active state of the high pressure module’ is understood a state where the high pressure module is not switched off, i.e. the motor driving the pump for transferring liquid from a low pressure to a high pressure is active. Thus, it is to be understood that the at least two different flow and/or pressure levels does not include an inactive or zero flow/pressure state of the high pressure module, i.e. the at least two different levels refers to flow and/or pressure levels useful in a normal cleaning operation of the high pressure cleaner.

By ‘high pressure cleaner’ is understood a cleaning device arranged to increase liquid pressure from a low pressure input to a high pressure output, wherein the device is capable of providing a liquid pressure of at least 5 bar, such as at least 10 bar, such as at least 20 bar, such as at least 40 bar, such as at least 60 bar in a maximum setting.

In the following, a number of embodiments and/or additional features will be described.

The high pressure module preferably comprises an electric motor arranged to drive a pump for transferring liquid from a low pressure at the liquid input to a high pressure at the liquid output, such as an electric motor arranged for being powered by a 115 V/230 V power output from the public electric network, or an electric motor arranged for bering powered by a battery, e.g. a lithium-ion battery. The controller is in such embodiments preferably arranged to electrically control the electric motor so as to adjust flow and/or pressure level at the liquid output between the plurality of different flow and/or pressure levels in the active state of the high pressure module, in accordance with the wireless control signal. Especially, the electric motor may be a DC type motor, e.g. a brush type electric motor, and wherein the controller is arranged to control electric power in a plurality of different levels in response to the wireless control signal from the remote control unit, so as to adjust flow and/or pressure level at the liquid output. Alternatively, the electric motor may be an AC type motor, such as an induction type electric motor, and wherein the controller comprises a frequency converter circuit arranged to control the electric motor, so as to adjust flow and/or pressure level at the liquid output.

The high pressure module may comprise a combustion engine arranged to drive a pump for transferring liquid from a low pressure at the liquid input to a high pressure at the liquid output. Especially, the controller may be arranged to control at least one operating parameter of the combustion engine, such as fuel injection and/or revolution speed, so as to adjust flow and/or pressure level at the liquid output between the plurality of different flow and/or pressure levels in the active state of the high pressure module, in accordance with the wireless control signal.

The controller may be arranged to switch off the high pressure module in accordance with a wireless control signal from the remote control unit, so as to allow the user to switch to an inactive state of the high pressure module from the remote control unit. Such remote switch on/off function may replace the traditional manually operable electric on/off switch on a high pressure cleaner. In case the high pressure module is driven by an electric motor, the switch off function may be provided by activating a switch for switching off electric power to the electric motor. Especially, the switch off function can be selected by the user as an additional setting in addition to the plurality of fluid and/or pressure level settings.

As an alternative to control of the motor/engine driving the high pressure pump, the controller may be is arranged to control a controllable valve so as to adjust flow and/or pressure level at the liquid output in accordance with the wireless control signal. Such controllable liquid valve may be activated by different types of actuators, as known by the skilled person, preferably an electrically controllable actuator.

The remote control unit and the controller are preferably arranged to communicate the wireless control signal by means of at least one of: radio frequency communication, ultrasonic communication, and infrared communication. Preferably, the controller is arranged to receive the wireless control signal in the form of a radio signal. Especially, such radio signal may have a frequency higher than 2400 MHz, however radio signals with lower frequencies, e.g. 1-2400 MHz may be used as well. The radio signal may use Gaussian frequency-shift keying or Quadrature amplitude modulation. The radio signal may be a Bluetooth compatible radio signal, however it is to be understood that other available frequency ranges or protocols may be used as well.

The controller may be arranged to select one of a plurality of preset flow and/or pressure levels in response to the wireless control signal. E.g. in the form of a step up one step, or step down one step between a plurality of preset steps in flow and/or pressure level in response to the wireless control signal. Alternatively, the user may enter a flow and/or pressure level value, and said value is then communicated in the wireless control signal.

The high pressure module and at least part of the controller, e.g. the entire controller including wireless receiver, may be arranged within one common housing, e.g. in the form of a machine cabinet with wheels and a handle to allow the user to easily transport the machine cabinet.

The high pressure cleaner preferably comprises a user interface for allowing the user to select a desired flow and/or pressure level, such as a user interface comprising at least one of: a push button, a touch control, and a turning knob to allow the user to input a desired flow and/or pressure level. Especially, the high pressure cleaner comprises a spray handle arranged for connection to the liquid output of the high pressure module, and to lead liquid to an output nozzle for spraying of liquid, so as to allow the user to navigate liquid spraying. Specifically, a trigger may be positioned on the spray handle, so as to allow the user to activate or disactivate a valve arranged to activating or disactivating liquid flow in response to activation of the trigger.

The user interface may be arranged on the spray handle, i.e. such that it allows the user to operate the user interface while navigating the spray handle. Such user interface is preferably connected to a wireless transmitter of the remote control unit, so as to allow the wireless transmitter to transmit the wireless control signal in accordance with an input from the user on the user interface. Especially, the user interface may comprise two push buttons to allow the user to select between the at least two different flow and/or pressure levels, such as having a first push button to allow the user to increase the flow and/or pressure level, and having a second push button to allow the user to decrease the flow and/or pressure level.

The high pressure cleaner may comprise a visual indicator arranged to display a status of a selected flow and/or pressure level setting of the high pressure module. E.g. in the form of a visual indicator comprising a plurality of light sources, and/or an LCD display, positioned on a spray handle of the high pressure cleaner. Especially, the visual indicator may be positioned near a user interface that allows the user to adjust the flow and/or pressure level. Especially, both of such user interface and the visual indicator are positioned on the spray handle.

The high pressure cleaner according may further comprise a wireless transmitter arranged to transmit a wireless status signal indicative of a status of the high pressure module to a remote control unit. E.g. such wireless status signal may be indicative of a flow and/or pressure level setting of the high pressure module. The wireless transmitter may be arranged together with the controller and may form a combined wireless receiver and transmitter, wherein the wireless receiver is arranged to receive said wireless control signal. The wireless transmitter is preferably arranged for transmitting the wireless status signal in response to an entered flow and/or pressure level setting of the high pressure module. The wireless status signal is preferably transmitted when the high pressure module has entered a new flow and/or pressure level state in response to a wireless control signal, and once the requested level has been entered, a wireless status signal is transmitted with a value indicating the entered flow and/or pressure level.

In a second aspect, the invention provides a method for controlling a high pressure cleaner with a high pressure module arranged for transferring liquid from a low pressure to a high pressure, the method comprising

receiving an input from a user regarding a change in a liquid flow and/or pressure level to be delivered by a high pressure module,

transmitting a wireless control signal in response to the input from the user,

receiving the wireless control signal, and

controlling the high pressure module to increase or decrease liquid flow and/or pressure delivered by the high pressure module in an active state of the high pressure module, in accordance with the wireless control signal.

It is appreciated that the same advantages and embodiments described for the first aspect apply as well for the second aspect. Further, it is appreciated that the described embodiments can be intermixed in any way between all the mentioned aspects.

### BRIEF DESCRIPTION OF THE FIGURES

The invention will now be described in more detail with regard to the accompanying figures of which

FIG. 1 illustrates a sketch of a user operating a high pressure cleaner embodiment,

FIGS. 2a and 2b illustrate sketches of a specific embodiment with a wireless remote control unit built into the spray handle of the high pressure cleaner with a user interface on a surface of an upper part of the spray handle,

FIG. 3 illustrates an electric circuit diagram of an high pressure cleaner embodiment including the wireless controller which can receive a wireless signal from a remote control unit and control the electric motor accordingly,

FIG. 4 illustrates an embodiment where various components of the remote control unit are located inside the spray handle, and

FIG. 5 illustrates steps of a method embodiment.

The figures illustrate specific ways of implementing the present invention and are not to be construed as being limiting to other possible embodiments falling within the scope of the attached claim set.

### DETAILED DESCRIPTION OF EMBODIMENTS

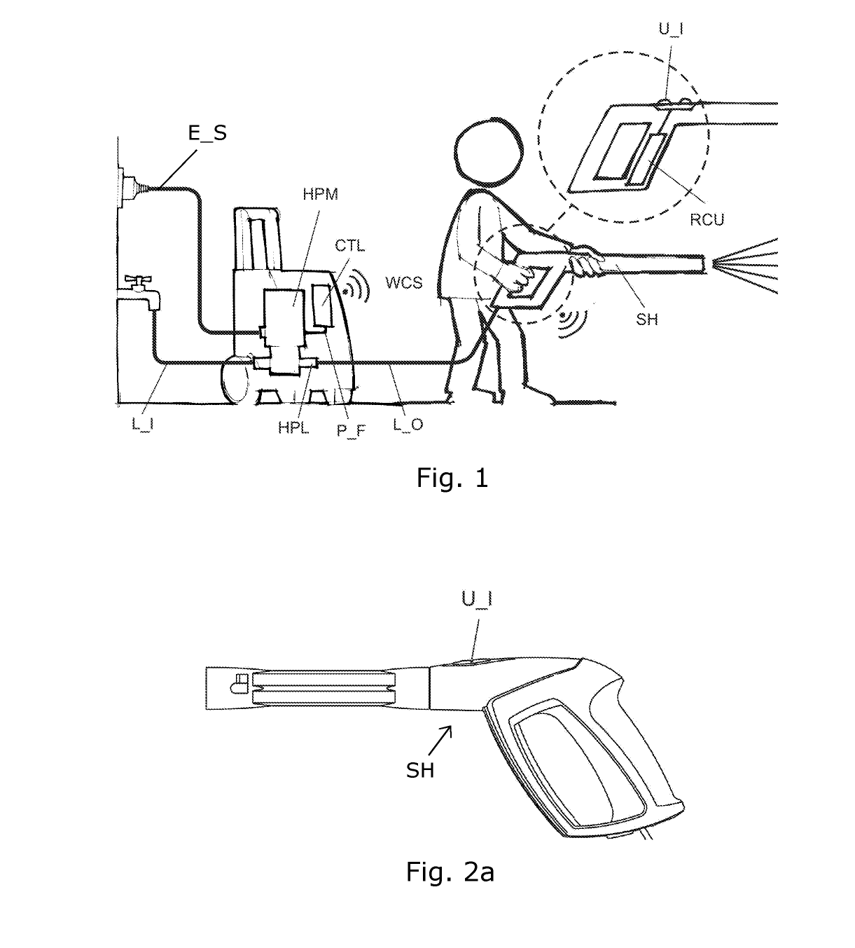

FIG. 1 illustrates a sketch of a user operating a high pressure cleaner embodiment, which allows the user to adjust liquid flow and/or pressure in an active state of the high pressure module HPM. The high pressure module HPM transfers liquid, e.g. water from a normal water tap, from a low pressure at a liquid input L_I to a high pressure HPL at a liquid output L_O, e.g. up to a pressure of maximum pressure of 100 Bar or more. In the shown embodiment, the high pressure module HPM has an electric motor powered from an electric source E_S in the form of a normal 230 V/115 V wall outlet.

A flexible hose connects the liquid output L_O from the high pressure module to a spray handle SH which in one end has a handle for the user to hold and navigate the spray handle SH, and a the opposite end liquid leaves the spray handle SH vi a nozzle. This allows the user to navigate liquid spraying during a cleaning operation. In the insert in FIG. 1, it is seen that a user interface U_I is arranged on the surface of the spray handle SH, and the user interface U_I is connected to a remote control unit RCU arranged inside the spray handle SH. The user interface U_I allows the user to adjust liquid flow and/or pressure level in an active state of the high pressure module HPM, e.g. by pushing an “increase” or “decrease” button which serves to select one of flow and/or pressure level settings, e.g. 2-10 different settings, during a cleaning procedure. The remote control unit RCU then transmits a wireless control signal WCS in response thereto.

This wireless control signal WCS is received by a wireless receiver in a controller CTL arranged within the same housing as the high pressure module HPM. In response to the wireless control signal WCS from the remote control unit RCU, the controller CTL controls the high pressure module HPM so as to adjust a flow and/or pressure level at the liquid output L_O of the high pressure module HPM. This is preferably done by controlling the electrical signal used to drive the electric motor of the high pressure module HPM. Once the desired flow and/or pressure level communicated in the wireless control signal WCS has been reached, the controller transmits a wireless status signal which is received by the remote control unit RCU in the spray handle, and which is then visualized to the user by means of a plurality of Light Emitting Diodes (LEDs) of the user interface U_I.

The electric power consumption for the electric motor in compact high pressure cleaners may be such as 0.5-2.0 kW, while in larger version the electric motor may consume more than 2.0 kW, e.g. more than 3.0 kW. The electric motor can be a brush type electric motor, or an induction type electric motor. It it so be understood that adjustment of flow and/or pressure generated by the high pressure module HPM can be obtained by appropriately controlling the electric signal applied to the electric motor driving the high pressure pump. Such electrical control should be performed with appropriate circuits depending on the motor type, such as known by the skilled person.

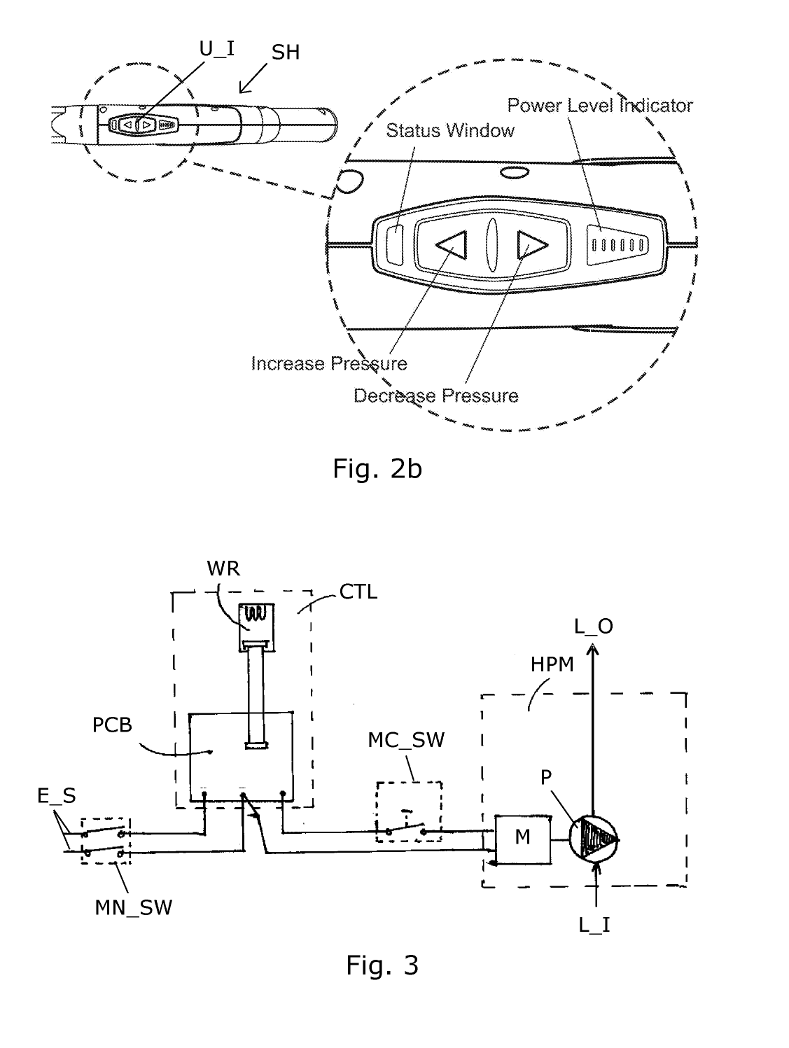

FIGS. 2a and 2b illustrate different views of one spray handle SH embodiment with a specific example of user interface U_I design and position on the spray handle. The spray handle SH is formed as a gun, and the user interface U_I is arranged at an upper surface of the spray handle SH which allow the user to operate the “increase pressure” and “decrease pressure” buttons and to see the power level indicated and status window during normal operation of the spray handle SH. The selected flow and/or pressure level is indicated in the form of 7 LEDs indicating the selected power level, since in the shown embodiment, flow and/or pressure level is adjusted by adjusting electric power to the electric motor driving the high pressure module HPM. When the lowest level is active, only one LED lights, while two LED lights when the high pressure module HPM is in level 2 etc. One of the 7 levels may be used to indicate a zero state, i.e. a state where the electric power to the electric motor is switched off, while the remaining 5 levels are different power levels in an active state of the high pressure module, i.e. where the electric motor is running.

Apart from the power level indicator, one single LED is used as a status window for communicating various status messages to the user. E.g. the status window may be used to indicate if the battery powering the remote control unit RCU is low, if the remote control unit RCU is actively connected, i.e. is wirelessly synchronized or paired, with a motor unit. Further, the status window may be used to indicate an error state, e.g. one or more of: lack of liquid input, motor overload, lack of electric power input, lack of radio contact with the motor unit containing the high pressure module HPM etc.

It is to be understood that the user interface U_I may alternatively or additionally have a turning knob or a touch panel for receiving input from the user. It is further to be understood that the remote control unit RCU and user interface U_I may be housed within a housing separate from the spray handle, e.g. as a dedicated remote control device.

The user interface U_I may comprise a dedicated push button or other to activate safety valve in the high pressure module.

FIG. 3 shows an electric diagram of components of a high pressure cleaner embodiment. Electrical power from an electric source E_S is applied to a main switch MN_SW capable of allowing the user to manually switch on/off power to the high pressure module HPM which comprises an electric motor M, e.g. a brush type or an induction motor, driving a high pressure pump P which serves to increase liquid pressure from liquid input L_I to liquid output L_O.

A controller CTL comprises a circuit board PCB with the control circuits that allows control of electric power to the electric motor M. A micro switch MC_SW serves to allow switching on/off electric power to the electric motor M upon mechanical activation by a pressure sensitive valve so as to maintain a liquid pressure within a desired range. The controller comprises a wireless receiver WR arranged to receive a wireless control signal in the form of a radio signal which has a message represented therein, and the message indicates a desired power level setting. The controller CTL then selects the desired power level accordingly. Preferably, all of the components indicated in the diagram of FIG. 3 are housed within one single housing.

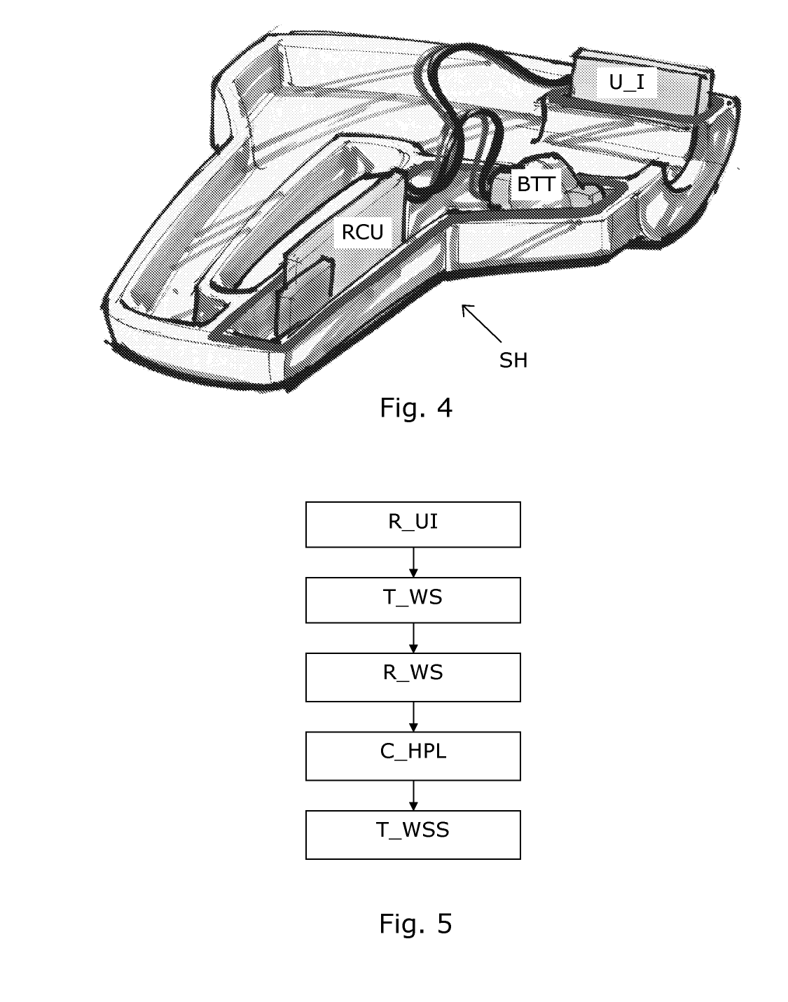

FIG. 4 shows a sketch of an opened spray handle SH embodiment in which all components required for implementation of a wireless remote control unit RCU including a lithium battery BTT, are positioned inside the spray handle SH when closed as for normal operation.

A user interface U_I is positioned such that its user operable controls are available from the surface of the spray handle SH, e.g. as shown in FIGS. 2a and 2b, during normal use.

FIG. 5 shows steps of a method for controlling a high pressure cleaner according to the invention. First step is receiving R_UI an input from a user regarding a change in a liquid flow and/or pressure level to be delivered by a high pressure module of the high pressure cleaner. Next, transmitting R_WS a wireless control signal in response to the input from the user, e.g. in the form of a radio signal from a remote control unit, e.g. arranged in the spray handle of the high pressure cleaner. Next, receiving R_WS the wireless control signal, e.g. at a receiver arranged within a housing also housing the high pressure module. Next, controlling C_HPL the high pressure module to increase or decrease liquid flow and/or pressure delivered by the high pressure module in an active state of the high pressure module, in accordance with the wireless control signal. Finally, transmitting T_WSS a wireless status signal, e.g. a radio signal, indicating when the high pressure module has entered the flow and/or pressure level requested in the wireless control signal. Such wireless status signal can then be visualized to the user by means of a symbol or a value on a display or be means of one or more light sources.

To sum up: the invention provides a high pressure cleaner with adjustable flow and/or pressure. A controller CTL serves to receive a wireless control signal WCS from a remote control unit RCU, e.g. integrated in the spray handle SH, in response to an input from a user. The controller CTL controls the high pressure module HPM, e.g. electric power to its electric motor, so as to adjust a flow and/or pressure level at the liquid output L_O of the high pressure module HPM in accordance with the wireless control signal WCS, between a plurality of different flow and/or pressure levels in an active state of the high pressure module HPM. Further, the controller may be arranged to switch off electric power to the motor of the high pressure module HPM and/or activate a safety valve in response to a 35 wireless control signal WCS. The user interface U_I that allows the user to enter the desired flow and/or pressure level, may further visualize the flow and/or pressure level to the user.

Although the present invention has been described in connection with the specified embodiments, it should not be construed as being in any way limited to the presented examples. The scope of the present invention is to be interpreted in the light of the accompanying claim set. In the context of the claims, the terms “including” or “includes” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A high pressure cleaner with adjustable flow and/or pressure, comprising
a high pressure module arranged for transferring liquid from a low pressure at a liquid input to a high pressure at a liquid output, and
a controller arranged to receive a wireless control signal from a remote control unit in response to an input from a user, wherein the controller is arranged to control the high pressure module so as to adjust a flow and/or pressure level at the liquid output between a plurality of different flow and/or pressure levels in an active state of the high pressure module, in accordance with the wireless control signal.

2. The high pressure cleaner according to claim 1, wherein the high pressure modulo comprises an electric motor arranged to drive a pump for transferring liquid from a low pressure at the liquid input to a high pressure at the liquid output.

3. The high pressure cleaner according to claim 2, wherein the controller is arranged to electrically control the electric motor so as to adjust flow and/or pressure level at the liquid output between the plurality of different flow and/or pressure levels in the active state of the high pressure module, in accordance with the wireless control signal.

4. The high pressure cleaner according to claim 3, wherein the electric motor is a DC type electric motor, and wherein the controller is arranged to control electric power in a plurality of different levels in response to the wireless control signal from the remote control unit, so as to adjust flow and/or pressure level at the liquid output.

5. The high pressure cleaner according to claim 3, wherein the electric motor is an AC type electric motor, and wherein the controller comprises a frequency converter circuit arranged to control the electric motor, so as to adjust flow and/or pressure level at the liquid output.

6. The high pressure cleaner according to claim 1, claims, wherein the high pressure module comprises a combustion engine arranged to drive a pump for transferring liquid from a low pressure at the liquid input to a high pressure at the liquid output.

7. The high pressure cleaner according to claim 6, wherein the controller is arranged to control at least one operating parameter of the combustion engine, so as to adjust flow and/or pressure level at the liquid output between the plurality of different flow and/or pressure levels in the active state of the high pressure module, in accordance with the wireless control signal.

8. The high pressure cleaner according to claim 1, wherein the controller is arranged to switch off the high pressure module in accordance with a wireless control signal from the remote control unit, so as to allow the user to switch to an inactive state of the high pressure module.

9. The high pressure cleaner according to claim 1, wherein the controller is arranged to receive the wireless control signal in a form of a radio signal.

10. The high pressure cleaner according to claim 1, wherein the remote control unit is a stand-alone unit.

11. The high pressure cleaner according to claim 1, wherein the controller is arranged to select one of a plurality of preset flow and/or pressure levels in response to the wireless control signal.

12. The high pressure cleaner according to claim 1, wherein the high pressure module and at least part of the controller are arranged within one common housing.

13. The high pressure cleaner according to claim 1, comprising a user interface for allowing the user to select a desired flow and/or pressure level.

14. The high pressure cleaner according to claim 13, comprising a spray handle arranged for connection to the liquid output of the high pressure module, and to lead liquid to an Output nozzle for spraying of liquid, so as to allow the user to navigate liquid spraying, wherein the user interface is arranged on the spray handle.

15. The high pressure cleaner according to claim 1, comprising a visual indicator arranged to display a status of a selected flow and/or pressure level setting of the high pressure module.

16. The high pressure cleaner according to claim 1, comprising a wireless transmitter arranged to transmit a wireless status signal indicative of a status of the high pressure module to a remote control unit.

17. A method for controlling a high pressure cleaner with a high pressure module arranged for transferring liquid from a low pressure to a high pressure,
receiving an input from a user regarding a change in a liquid flow and/or pressure level to be delivered by a high pressure module,
transmitting a wireless control signal in response to the input from the user,
receiving the wireless control signal, and
controlling the high pressure module to increase or decrease liquid flow and/or pressure delivered by the high pressure module in an active state of the high pressure module, in accordance with the wireless control signal.
